(19) United States
(12) Patent Application Publication
(10) Pub. No.: US 2008/0186826 A1
(43) Pub. Date: Aug. 7, 2008

(54) OPTICAL RECORDING MEDIUM AND OPTICAL RECORDING APPARATUS

(75) Inventor: Ippei MATSUMOTO, Yokohama-shi (JP)

Correspondence Address: COOPER & DUNHAM, LLP, 1185 AVENUE OF THE AMERICAS, NEW YORK, NY, 10036, US

(73) Assignee: Ricoh Company, Ltd., Tokyo (JP)

(21) Appl. No.: 12/025,395

(22) Filed: Feb. 4, 2008

Related U.S. Application Data
(63) Continuation of application No. PCT/JP2006/318443, filed on Sep. 11, 2006.

(30) Foreign Application Priority Data
Sep. 15, 2005 (JP) 2005-268069
Sep. 16, 2005 (JP) 2005-270715

(51) Int. Cl. G11B 3/74

(52) U.S. Cl. 369/94

(57) ABSTRACT

To provide an optical recording medium that includes a substrate and a multilayered recording layer disposed on or over the substrate and where information is recorded by irradiating the recording layer with a laser beam to cause change in its optical characteristics, wherein judgment information concerning a recording condition for the optical recording medium is previously recorded so as to be readable by irradiation with a laser beam.

### CROSS-REFERENCE TO RELATED APPLICATIONS

This is a continuation of Application No. PCT/JP2006/318443, filed on Sep. 11, 2006.

### BACKGROUND OF THE INVENTION

1. Field of the Invention

The present invention relates to an optical recording medium, more specifically to an optical recording medium capable of recording, such as a compact disc (CD-R/RW), DVD-R/RW, and DVD+R/+RW, and to an optical recording apparatus used for recording on the optical recording medium.

2. Description of the Related Art

As the storage capacity of information recording media has been increasing year after year, various methods have been under study for increased storage capacity. As one of such methods, an optical recording medium (optical disc) that has multiple date faces (or a multilayered recording layer) has been under study.

For example, different conventional multilayered optical recording media have different servo characteristics and adopt different recording methods depending on the method of manufacturing them (i.e., the method of forming a recording layer). Thus, in general, optimal recording cannot be achieved since information concerning the manufacturing method is not recorded in the optical recording medium, resulting in poor record quality which in turn may cause recording and reproducing failure.

To avoid this problem, a technology is disclosed in which a servo layer is previously formed in a bulk optical recording medium for focusing and tracking, whereby information is precisely recorded in a data layer provided at a position corresponding to the servo layer (see Japanese Patent Application Laid-Open (JP-A) No. 2002-312958). Conventional optical recording media are ones in which servo signals for precise information recording and information reproducing are embedded in some ways and excellent recording performance is achieved by means of such servo signals.

[Japanese Patent Application Laid-Open (JP-A) No. 2002-63738, Japanese Patent Application Laid-Open (JP-A) No. 2003-87561, International Publication No. WO01/099103, Japanese Patent (JP-B) No. 3128313, Japanese Patent Application Laid-Open (JP-A) No. 07-50014, Japanese Patent (JP-B) No. 3643179, Japanese Patent (JP-B) No. 3209126, Japanese Patent Application Laid-Open (JP-A) No. 2001-67721].

There are, however, a number of different types of optical recording media and thus servo characteristics and recording methods differ depending on the media type. For this reason, it has been difficult to set an optimal recording condition for each media type and, heretofore, recording and reproducing failure has occurred due to poor record quality.

The present invention has been accomplished in view of the foregoing problems, and an object of the present invention is to provide an optical recording medium that can achieve excellent recording by setting an optimal recording condition depending on the media type.

Another object of the present invention is to provide an optical recording apparatus that can stably record information with excellent record quality even on optical recording media that have been manufactured with different methods (different methods of forming a recording layer).

### SUMMARY OF THE INVENTION

The present inventors have focused on the fact that multilayered optical recording media have different servo characteristics and adopt different recording methods depending on the method of manufacturing them (i.e., the method of forming a recording layer).

The means to solve the foregoing problems are as follow:

<1> An optical recording medium including: a substrate; and a multilayered recording layer disposed on or over the substrate, wherein judgment information concerning a recording condition for the optical recording medium is previously recorded in such a way that the information can be read out by irradiation with a laser beam, and wherein information is recorded by irradiating the recording layer with a laser beam to cause change in its optical characteristics.

With the optical recording medium according to <1>, it is possible to set an optimal recording condition for each optical recording medium on the basis of the judgment information, thereby achieving excellent recording performance.

<2> The optical recording medium according to <1>, wherein the judgment information concerns a method of forming the recording layer.

<3> The optical recording medium according to <2>, wherein the judgment information identifies the method of forming the recording layer on the basis of the presence or absence of information recorded in the substrate.

<4> The optical recording medium according to <2>, further including a groove to be scanned with a laser beam upon recording of information in the recording layer, wherein the judgment information indicates that the thickness of the recording layer provided on convex and concave portions formed by the groove differs depending on the method of forming the recording layer.

With the optical recording medium according to any one of <2> to <4>, it is possible to set an optimal recording condition for each optical recording medium on the basis of the information concerning the method of forming a recording layer, thereby achieving excellent recording performance. This is particularly suitable for an optical recording medium having a plurality of recording layers.

<5> The optical recording medium according to any one of <1> to <4>, wherein the recording layer is formed by applying a liquid recording material.

With the optical recording medium according to <5>, it is possible to provide an optical recording medium with judgment information that can be used in any reproducing apparatus.

<6> The optical recording medium according to any one of <4> to <5>, wherein the judgment information is recorded as wobble of the groove.

With the optical recording medium according to <6>, it is possible to achieve high-density judgment information recording by providing the groove with the judgment information.

<7> The optical recording medium according to any one of <1> to <6>, wherein the judgment information is recorded as information that has been phase-modulated.

<8> The optical recording medium according to any one of <1> to <7>, wherein the judgment information is contained in one of manufacturer information and version information of the optical recording medium.

<9> The optical recording medium according to any one of <1> to <8>, wherein in a case where the optical recording medium is one of a DVD+R recording medium and a DVD+RW recording medium, the judgment information is contained in revision information of the optical recording medium.

<10> The optical recording medium according to <9>, wherein in a case where the revision information is 1 byte information, the judgment information is recorded within top 5 bits of the revision information.

With the optical recording medium according to any one of <7> to <10>, it is possible to provide an optical recording medium with judgment information that can be used in any conventional recording apparatus.

<11> An optical recording apparatus including the functions of: reading out, as judgment information concerning a recording condition for an optical recording medium, information concerning a method of forming a recording layer from the optical recording medium; comparing the information thus read out with previously recorded information concerning a method of forming a recording layer; and setting servo characteristics and/or a recording beam waveform that correspond to the method of forming a recording layer, the method having been identified as a result of the comparison, wherein, upon recording on an optical recording medium having information concerning the method of forming a recording layer recorded therein, a recording method is changed to a recording method that corresponds to the method, and

wherein the optical recording medium comprises a substrate and a multilayered recording layer disposed on or over the substrate, wherein information is recorded by irradiating the recording layer with a laser beam to cause change in its optical characteristics.

<12> The optical recording apparatus according to <11>, wherein a recording beam waveform is changed when the recording method is changed according to the method of forming a recording layer.

<13> The optical recording apparatus according to one of <11> and <12>, wherein servo characteristics are changed when the recording method is changed according to the method of forming a recording layer.

With the optical recording medium according to any one of <11> to <13>, it is possible to provide an optical recording apparatus that can stably record information with excellent record quality even on optical recording media that have been manufactured with different methods (different methods of forming a recording layer), as well as on multilayered optical recording media (optical recording media having multiple recording layers) that are more susceptible to the influence of change in the method of forming a recording layer.

<14> The optical recording apparatus according to any one of <11> to <13>, wherein in a case where manufacturer information and/or version information of the optical recording medium is read out and it is determined that a recording method corresponding to the manufacturer information and/or version information is recorded in the optical recording medium before starting recording, recording is performed using the recording method.

With the optical recording apparatus according to <14>, it is possible to provide an optical recording apparatus that can ensure excellent record quality and excellent recording operations for known optical recording media.

### BRIEF DESCRIPTION OF THE DRAWINGS

FIG. 1 is cross-sectional view showing a configuration example (1) of an optical recording medium according to the present invention.

FIG. 2 is cross-sectional view showing a configuration example (2) of the optical recording medium according to the present invention.

FIG. 3 is a block diagram showing a configuration of an optical recording apparatus that is suitable for the optical recording medium of the present invention.

FIG. 4 is a block diagram showing a configuration example of an information processing apparatus equipped with the optical recording apparatus shown in FIG. 3.

FIG. 5 is a flowchart shown an example of a procedure as to how recording conditions are set for an optical recording medium in the optical recording apparatus shown in FIG. 3.

FIG. 6 shows an example of manufacturing method information format (to be) recorded in the optical recording medium of the present invention.

FIG. 7 shows an example of processing performed in a conventional optical recording apparatus.

### DESCRIPTION OF THE PREFERRED EMBODIMENTS

Hereinafter, the configuration of an optical recording medium according to the present invention will be described.

The optical recording medium according to the present invention is an optical recording medium that has a substrate and multiple recording layers (multiple recording layer) disposed on or over the substrate and that records information by irradiating the recording layer with a laser beam to cause change in its optical characteristics, wherein judgment information concerning a recording condition for the optical recording medium is previously recorded in such a way that it can be read out by irradiation with a laser beam.

As used herein, “optical recording medium” means a writable (recordable) digital versatile disc (DVD), such as DVD-RAM-WO, DVD-R, DVD+R, DVD-RAM, DVD-RW, and DVD+RW. Note that DVD-RAM-WO, DVD-R, and DVD+R are write-once discs (also referred to as “DVD Write Once”), and that DVD-RAM, DVD-RW, and DVD+RW are rewritable discs.

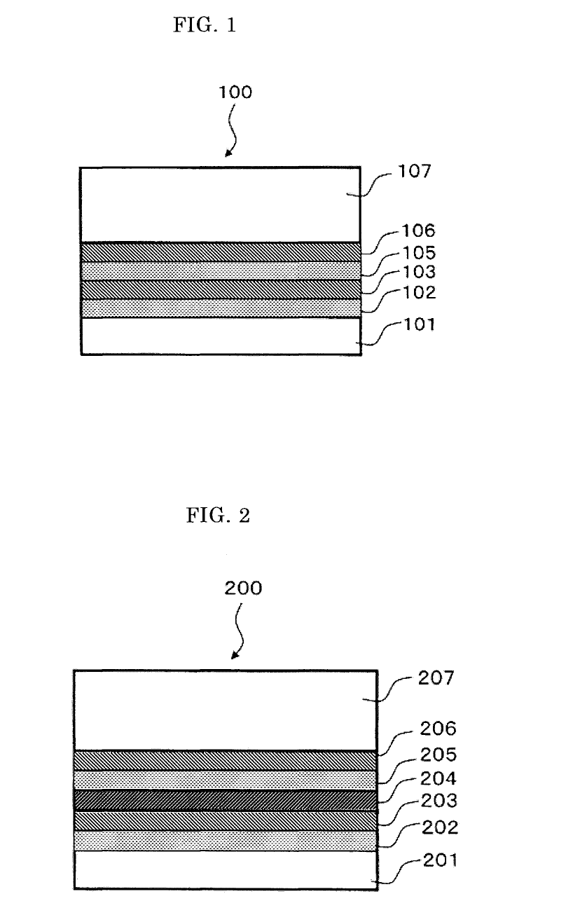

An undercoat layer or a protective layer may be provided between the recording layer and the substrate. Alternatively, two or more of each of the undercoat and protective layers may be provided for improved function; configuration examples thereof are shown in FIGS. 1 and 2.

FIG. 1 shows, as an optical recording medium 100 of the present invention, a dual layer optical recording medium consisting of a first substrate 101 (one close to the laser beam entrance side), an L0 recording layer 102, an L0 reflective layer 103, an adhesion layer (not shown), an L1 recording layer 105, an L1 reflective layer 106, and a second substrate (protective substrate) 107.

FIG. 2 shows, as an optical recording medium 200 of the present invention, a dual layer optical recording medium consisting of a first substrate 201 (one close to the recording beam entrance side), an L0 recording layer 202, an L0 reflective layer 203, a groove forming layer 204 for L1 recording, an L1 recording layer 205, an L1 reflective layer 206, and a second substrate (protective substrate) 207.

The constituent materials for the layers in the optical recording medium 100 may be identical to those for the layers in the optical recording medium 200.

It is required that the first substrates 101 and 201 admit a laser beam (i.e., transparent) in a case where information is recorded on or reproduced from the optical recording medium from the substrate side, but they are not required to admit the laser beam in a case where information is recorded on or reproduced from the optical recording medium from the recording layer side. Examples of the constituent materials for the first substrate include plastics such as polyester resins, acrylic resins, polyamide resins, polycarbonate resins, polyolefin resins, phenol resins, epoxy resins and polyimide resins, glass, ceramics, and metals. The surface of the substrate may be provided with grooves and/or pits for tracking, and further with pre-formats such as address signals.

It is required that the second substrate admit a laser beam in a case where it is applied from the second substrate side, but the second substrate is not required to admit the laser beam in a case where it only serves as a protective plate.

The constituent materials to be adopted to form the second substrates are identical to those for the first substrates, and it is possible to reduce manufacturing costs by using the same materials.

The recording layers 102, 105, 202 and 205 are ones that record information therein by irradiation with a laser beam which causes some changes in their optical characteristics, and are made of material having organic dye as a main ingredient. As used herein, the term “main ingredient” means a sufficient amount of organic dye required to record or reproduce information. In general, only organic dyes are used except for small amounts of additives that are added on an as-needed basis. The recording layer may be either a single layer consisting of an organic dye layer or a lamination layer consisting of an organic dye layer and a reflective layer for increased reflectivity.

Examples of such organic dyes include azo dyes, formazan dyes, dipyrromethene dyes, (poly)methine dyes, napthalocyanine dyes, phthalocyanine dyes, tetraazaporphyrin dyes, squarylium dyes, chloconium dyes, pyrylium dyes, naphthoquinone dyes, anthraquinone dyes (indanthrene dyes), xanthene dyes, triphenylmethane dyes, azulene dyes, tetrahydrocoline dyes, phenanthrene dyes, triphenothiazine dyes, and metal complexes thereof. Among these dyes, azo(metalchelate) dyes, formazan(metalchelate) dyes, squarylium(metalchelate) dyes, dipyrromethene(metalchelate) dyes, trimethynecyanine dyes, and tetraazaporphyrin dyes are preferable.

For the thermal decomposition property of the foregoing dyes, the initial decomposition temperature or kick-off temperature is preferably 100° C. to 360° C. and, more preferably, 100° C. to 350° C. If the initial decomposition temperature is greater than 360° C., it may result in poor pit formation upon recording to cause increase in jitter. If the initial decomposition temperature is less than 100° C., the disc storage stability may be reduced.

The dyes described above may be added with additional organic dye(s), metal(s) and/or metal compound(s) in order to improve their optical characteristics, recording sensitivity and/or signal characteristics. Alternatively, a lamination layer consisting of a dye layer and a layer made of organic dye, metal and/or metal compound may be provided.

Examples of such additional metals and metal compounds include In, Te, Bi, Se, Sb, Ge, Sn, Al, Be, TeO₂, SnO, As and Cd. Each of these metals and metal compounds may be dispersed and mixed before use.

Furthermore, for example, polymer materials such as ionomer resins, polyamide resins, vinyl resins, natural polymers, silicones and/or liquid rubbers, or silane coupling agents may be dispersed and mixed in the foregoing dyes. It is also possible to add a stabilizer (e.g., a transition metal complex), dispersing agent, flame-retardant, lubricant, antistatic agent, surfactant, and/or plasticizer together with the dyes for the purpose of improving their characteristics.

The recording layers 102, 105, 202 and 205 may be formed by means of a conventional method such as a vapor deposition method, sputtering method, CVD method, or coating method using a solvent. In a case of the coating method the foregoing dyes and the like are in an organic solvent to form a coating solution, followed by the application of the coating solution using a conventional coating method such as spray coating, roller coating, dip coating, or spin coating.

Examples of the organic solvent for use include alcohols such as methanol, ethanol and isopropanol; ketones such as acetone, methyl ethyl ketone and cyclohexanone; amides such as N,N-dimethylformamide and N,N-dimethylacetamide; sulfoxides such as dimethylsulfoxide; ethers such as tetrahydrofuran, dioxane, diethylether and ethyleneglycol monomethylether; esters such as methyl acetate and ethyl acetate; aliphatic halogenated hydrocarbons such as chloroform, methylene chloride, dichloroethane, carbon tetrachloride, and trichloroethane; aromatics such as benzene, xylene, monochlorobenzene, and dichlorobenzene; cellosolves such as methoxy ethanol and ethoxy ethanol; and hydrocarbons such as hexane, pentane, cyclohexane and methyl cyclohexane.

The thickness of the recording layers 102, 105, 202 and 205 is preferably 10 nm (100 angstrom) to 10 μm and, more preferably, 20 nm to 200 nm (200 angstrom to 2,000 angstrom).

Examples of the materials for the reflective layers 103, 106, 203 and 206 include metals and semimetals such as Au, Ag, Cr, Ni, Al, Fe, and Sn, which can offer high reflectivity and high resistance to corrosion as a single element. Among these, Au, Ag, and Al are particularly preferred in view of their reflectivity and productivity. These metals and semimetals may be used singly or in combination of two or more as an alloy. Examples of the method of forming the reflective layers 103, 106, 203 and 206 include a vapor deposition method and sputtering method, and their thickness is preferably 5 nm to 500 nm (50 angstrom to 5,000 angstrom) and, more preferably, 10 nm to 300 nm (100 angstrom to 3,000 angstrom).

The materials for the adhesion layer are not particularly limited as long as two identical optical recording medium can be bonded together; UV curable adhesives and hot-melt adhesives are preferable in view of productivity. It is preferable to use UV curable resin for the groove forming layer 204. In this case, it is preferable to use a material that is suitable for the separation of a stamper for forming the groove for L1 recording.

It is also preferable to provide an undercoat layer to protect the L0 reflective layers 102 and 202 from corrosion.

An undercoat layer is provided to (1) improve adhesive property, to (2) protect other layers against water or gas, to (3) improve the shelf life of the recording layer, to (4) improve reflectivity, to (5) protect the substrate from solvents, and to (6) form grooves, pits, pre-formats, and the like thereon. To attain the above-noted purpose (1), various polymer compounds such as ionomer resins, polyamide resins, vinyl resins, natural resins, natural polymers, silicones, and liquid rubbers, and silane coupling agents may be employed. To attain the purposes (2) and (3), inorganic compounds such as SiO, MgF, SiO₂, TiO, ZnO, TiN and SiN can be used in addition to the above-described polymer materials. Further, metals and semimetals such as Zn, Cu, Ni, Cr, Ge, Se, Au, Ag and Al can also be used. To attain the purpose (4), organic thin films with metallic luster, which are made of metals such as Al, Au and Ag, methine dye or xanthene dye, may be used. To attain the purposes (5) and (6), UV curable resins, thermosetting resins, and thermoplastic resins and the like can be used.

The thickness of the undercoat layer can be properly determined depending on the intended purpose; preferably, the thickness is 0.01 μm to 30 μm and, more preferably, 0.05 μm to 10 μm.

Where necessary, a protective layer or a hard coat layer may also be provided.

The protective layer or the hard coat layer is provided in order to (1) protect the recording layer (reflection absorbing layer) from scratches, dust, dirt, etc., to (2) improve the shelf life of the recording layer (reflection absorbing layer), and to (3) improve reflectivity. To achieve these purposes, materials similar to those used to produce the undercoat layer can be used. It is also possible to use such organic materials as thermosoftening resins and thermofusible resins; examples include polymethyl acrylate resins, polycarbonate resins, epoxy resins, polystyrene resins, polyester resins, cellulose resins, aliphatic hydrocarbon resins, aromatic hydrocarbon resins, natural rubbers, styrene-butadiene resins, chloroprene rubbers, waxes, alkyd resins, drying oils and rosins. Among these, UV curable resins are preferable in view of excellent productivity.

The thickness of the protective layer or hard coat layer is typically 0.01 μm to 30 μm and, more preferably, 0.05 μm to 10 μm.

As in the case of the recording layer, it is possible to add a stabilizer, dispersing agent, flame-retardant, lubricant, antistatic agent, surfactant, and/or plasticizer to the undercoat layer, protective layer and the hard coat layer.

It is also required that the second substrates 107 and 207 admit a laser beam in a case where the laser beam is applied from the second substrate (protective substrate) side, but they are not required to admit the laser beam when used simply as protective plates. The constituent materials to be adopted to form the second substrate (protective layer) are identical to those for the first substrates—plastics such as polyester resins, acrylic resins, polyamide resins, polycarbonate resins, polyolefin resins, phenol resins, epoxy resins and polyimide resins, glass, ceramics, and metals can be used. Moreover, it is possible to reduce manufacturing costs by using the same materials.

The method of manufacturing a dual layer optical recording medium, or the method of forming a recording layer, is of two types.

The first is the “inverse stack” method in which the L0 recording layer 102 and L0 reflective layer 103 are formed on the first substrate 101, the L1 reflective layer 106 and L1 recording layer 105 are formed on the second substrate 107, and the first and second substrates are bonded together using an adhesion layer.

The second is the “2P (photopolymer)” method in which the L0 recording layer 202 and L0 reflective layer 203 are first formed on the first substrate 201, the groove forming layer 204 is stacked on the L0 reflective layer 203, a recording groove is formed on the groove forming layer 204, the L1 recording layer 205 and L1 reflective layer 206 are formed on the groove forming layer 204, and the second substrate 207 is bonded to the L1 reflective layer 206.

The two methods differ in that the shapes of recording grooves for the L0 recording layer and L1 recording layer differ and that the direction in which a recording beam is incident differs. For example, with the inverse stack method, the L0 recording layer 102 is formed on the groove-formed surface of the first substrate 101—a substrate on the beam irradiation side, and the L1 recording layer 105 is formed over the groove-formed surface of the second substrate 107. On the other hand, with the 2P method, the L0 recording layer 202 is formed on the groove-formed surface of the first substrate 201—a substrate on the beam irradiation side, and the L1 recording layer 205 is formed on the groove-formed surface of groove forming layer 204. When it is assumed that these recording layers are formed by application of a liquid recording material to the corresponding layers, the resulting recording layers differ in thickness due to the difference in the shapes of recording grooves between the two methods. Accordingly, the thickness of the L1 recording layers 105 and 205, corresponding to the concave and convex portions formed by their respective recording grooves (i.e., the recording groove of the second substrate 107 in a case of the inverse stack method, and the recording groove of the groove forming layer 204 in a case of the 2P method), differs between the two methods. For this reason, optimal servo conditions and an optimal shape of a beam waveform differ depending on the media type.

The judgment information that is previously recorded in the optical recording medium of the present invention, which the information concerns the recording condition for the optical recording medium, is preferably information concerning the manufacturing method of such an optical recording medium as described above, more preferably information concerning the method of forming the recording layers. Moreover, the judgment information preferably indicates the fact that the thickness of the recording layers provided on concave and convex portions formed by their respective recording grooves differs depending on the method of forming the recording layers.

The judgment information may be information that identifies the type of the forming method of the recording layers on the basis of the presence or absence of information recorded in the substrate. For example, in the case of an optical recording medium manufactured with the inverse stack method, it is assumed that given information is recorded in the substrate 101, whereas in the case of an optical recording medium manufactured the 2P method, it is assumed that given information is not recorded in the substrate 201.

It is also preferable that the judgment information (recording information) be incorporated in manufacturer information or version information which can be arbitrarily added by the disc manufacturer.

In the case of a DVD+R_DL (dual layer optical recording medium), the judgment information is incorporated in the revision information which can be arbitrarily added by the disc manufacturer, thereby eliminating the need to consider its compatibility with other existing drives.

In addition, in the case of a DVD+R disc or a DVD+RW disc, it is desirable that the judgment information be incorporated in the revision information of the optical recording medium, which can be arbitrarily added by the disc manufacturer. This also eliminates the need to consider its compatibility with other existing drives. Moreover, when the revision information is 1 byte information, it is preferable that the judgment information be recorded within top 5 bits of the revision information.

The judgment information concerning the recording conditions for an optical recording medium is preferably recorded as wobble of the groove (the recording groove of the first substrate 101 and/or the second substrate 107 and the recording groove of the first substrate 201 and/or the groove forming layer 204) that is scanned with a laser beam upon recording of information in the recording layer. In addition, the judgment information is preferably phase-modulated before recorded in the recording layer. This enables, in an optical recording apparatus to be described later, reading out of the judgment information together with other information which can be read out by scanning the recording grooves upon recording in the recording layers.

As described above, additional information is provided to a recording groove of an optical recording medium to achieve identification of judgment information concerning the recording condition for it (i.e., the method adopted to manufacture the optical recording medium). This information is read out only by an optical recording apparatus and thus there is no need to consider its compatibility with reproducing apparatus. The recording density can also be increased by converting the information into high-frequency signals by phase modulation.

Although an example of a dual layer optical recording medium having two recording layers has been described above, the methods of forming recording grooves and recording layers are substantially the same as those adopted to manufacture a multilayered optical recording medium having three or more recording layers; therefore, the present invention can also be implemented for such a multilayered optical recording medium.

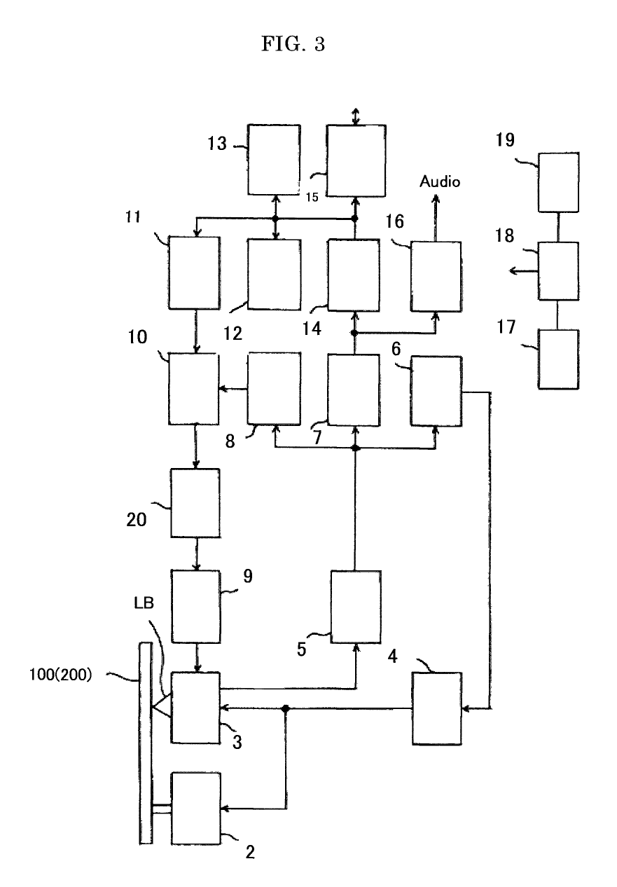

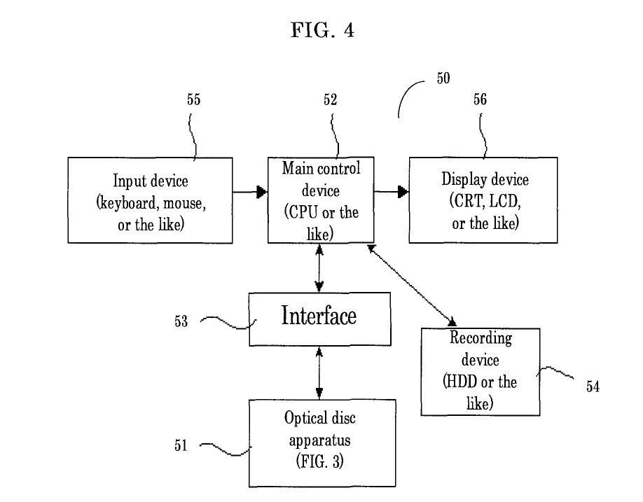

Information is recorded on or reproduced from the optical recording medium of the present invention by means of a recording apparatus like that shown in FIG. 3.

FIG. 3 is a functional block diagram exemplarily showing the essential parts of the optical recording apparatus. In this drawing 100(200) denotes an optical recording medium; 2, a spindle motor; 3, an optical pickup; 4, a motor driver; 5, a read amplifier; 6, a servo unit; 7, a DVD decoder; 8, an ADdress In Pre-groove (ADIP) decoder; 9, a laser controller; 10, a DVD encoder; 11, a DVD-ROM encoder; 12, a buffer RAM; 13, a buffer manager; 14, a DVD-ROM decoder; 15, an ATAPI/SCSI interface; 16, a D/A converter; 17, a ROM; 18, a CPU; 19, a RAM; 20, a pulse generator; LB, a laser beam; and Audio, audio output signals.

In FIG. 3 arrows indicate the main directions of data flow. For simplification, it is assumed that the CPU 18 controlling the blocks in FIG. 3 is connected to each block by attaching only a heavy line to it. The ROM 17 stores a control program written in codes that can be decoded by the CPU 18. When the optical recording apparatus is turned on, the program is loaded onto a main memory (not shown), and then the CPU 18 controls the operation of each block in accordance with the program and stores data required for control into the RAM 19 on a temporary basis. The configuration and operation of the optical recording apparatus are as follows: The optical recording medium 100(200) is driven to rotate by the spindle motor 2. The spindle motor 2 is controlled by the motor driver 4 and servo unit 6 in such a way that the linear velocity or angular velocity becomes constant. The linear velocity or angular velocity may be changed stepwise.

The optical pickup 3 incorporates a semiconductor laser, optical system, focus actuator, track actuator, light-receiving device, and position sensor (not shown respectively), and applies the laser beam LB onto the optical recording medium 100(200). The optical pickup 3 can be moved in a sledge direction by use of a seek motor. The focus actuator, track actuator and seek motor are controlled by the motor driver 4 and servo unit 6 according to signals from a light-receiving element and a position sensor in such a way as to locate the spot of the laser beam LB on the intended position of the optical recording medium 100(200).

Upon reading, reproduction signals obtained using the optical pickup 3 are amplified and binarized by the read amplifier 5, and inputted to the DVD decoder 7. The binarized data bits thus inputted are reconstructed through a process of 8/16 demodulation at the DVD decoder 7, where recording data bits are treated as sets of 8 bits for conversion into 16 bits. In this case, binder bits are assigned such that the prior numbers of “1” and “0” appear equally on average, which is referred to as “suppression of DC component” by which fluctuations in the slice level of DC cut reproduction signals can be suppressed.

The demodulated data are then subject to deinterleaving and error correction, and transmitted to the DVD-ROM decoder 14 for further error collection for increased data reliability. The data, which have been subjected to error collection twice, are temporarily stored on the buffer RAM 12 by means of the buffer manager 13. When a sufficient amount of data is stored to define sector data, the sector data are then transferred to a host computer (not shown) at a time via an ATAPI/SCSI interface 15. In the case of music data, data outputted from the DVD decoder 7 are inputted in the D/A converter 16, and are readout as analog audio signals “Audio.”

Upon writing, the data transmitted from the host computer via the ATAPI/SCSI interface 15 are temporarily stored in the buffer RAM 12 by means of the buffer manager 13. Before a writing operation is started, the laser spot has to be positioned at a write start point. In DVD+R/+RW discs, this position can be identified on the basis of wobble signals from wobble tracks previously provided on the optical recording medium 100(200).

Note that the write start position can be identified on the basis of land pre-pits rather than on wobble signals in a case of DVD-RW/-R discs, and on the basis of pre-pits in a case of DVD-RAM/RAM•WO discs.

The wobble signal in DVD+RW/R+discs contain address information called ADIP (Adress In Pre-groove), and is readout by the ADIP decoder 8. The synchronized signal produced by the ADIP decoder 8 is transmitted to the DVD encoder 10, thereby allowing data to be written on accurate positions of the optical recording medium 100(200). The data in the buffer RAM 12 are transmitted to the DVD-ROM encoder 11 and/or DVD encoder 10 for error correction code addition and interleaving, and then subjected to 8/16 modulation as a recording signal.

The waveform of the modulated signal is converted by the pulse generator 20 such that it is suitable for the optical recording medium 100(200), and recorded in the recording medium 100(200) via the laser controller 9 and optical pickup 3. Correction of optical pickup efficiency can be directly made by measuring the level of diffracted light of the recording beam using a light-receiving element and changing the recording power of the laser controller 9 on the basis of the change in the level of the diffracted light. Correction of the recording power for an optical recording medium can be made by measuring recording power efficiency for the recording medium on the basis of the change in the level of reflected light generated after recording and correcting the recording power of the laser controller 9. Address controlling may be made using address information from land pre-pits and/or pre-pits.

FIG. 4 is a schematic diagram of an information processing apparatus using an optical recording apparatus for this optical recording medium. The information processing apparatus 50 includes an optical disc apparatus (recording apparatus) 51, a main control device 52, an interface 53, a recording device (HDD) 54, an input device 55, a display device 56, and the like.

The main control device 52 includes a microcomputer (not shown), a main memory (not shown) and the like, and controls the overall operation of the information processing apparatus 50 (or host computer.

The interface 53 is a communication interface for bilateral communication with the optical disc apparatus 51, and complies to standard interface such as ATAPI or SCSI. When the optical recording apparatus shown in FIG. 3 is used as an optical disc apparatus, the interface 53 is connected to the foregoing interface 15 of the optical disc apparatus (see FIG. 3). The two interfaces may be connected together by means of not only cable connection using a communication line or cable (e.g., SCSI cable), but also by infrared wireless connection or the like.

The recording device 54 (e.g., HDD or hard disc) stores a program written in codes that can be decoded by the microcomputer of the main control device 52. When the driving power source of the information processing apparatus 50 is turned on, the program is loaded onto the main memory of the main control device 52.

The display device 56 is equipped with a display part (not shown) such as a CRT, a liquid crystal display (LCD) or a plasma display panel (PDP), and displays various information received from the main control device 52.

The input device 55 is equipped with at least one input medium (not shown), such as those selected from a keyboard, a mouse, and a pointing device, and transmits a variety of user-input information to the main control device 52. Note that information from a loaded medium may be inputted wirelessly. Incidentally, CRTs equipped with a touch panel may be available as an integrated device of the display device 56 and input device 55.

The information processing apparatus 50 is equipped with an operating system (OS). Every device constituting the information processing apparatus 50 is controlled by the operating system.

The optical recording apparatus that can provide the effect of the present invention can be realized by an optical recording apparatus having at least: a function of reading out, as judgment information concerning a recording condition for the optical recording medium 100(200), information concerning the manufacturing method thereof (i.e., the method of forming a recording layer) from the optical recording medium 100(200); a function of comparing the information thus read out with previously recorded information concerning a manufacturing method; and a function of setting a recording condition (servo characteristics and/or a recording beam waveform) that corresponds to the manufacturing method identified as a result of the comparison. Upon recording on an optical recording medium having information concerning the manufacturing method thereof recorded therein, a recording method is thereby changed to one that corresponds to that manufacturing method. These functions can be accomplished by means of one or more of units provided in the optical recording apparatus of the present invention.

For example, when the optical recording apparatus (recording and reproducing apparatus) shown in FIG. 3 is used, the effect of the present invention can be brought about by providing the CPU 18 with a function of calculating an optimal recording beam waveform according to the identified recording condition and providing the pulse generator 20 with a function that enables recording by changing the beam waveform. Preferably, the condition under which the recording beam waveform is changed corresponds to the change in the set value of the recording power of the laser controller 9.

Moreover, it is preferable to use an optimal recording method for every optical recording media in the following manner: when an optimal recording condition has already been set in the manufacturer information and/or version information of an optical recording medium upon recording, that recording condition is used, and the read-out information concerning the manufacturing method is used only for an optical recording medium whose optimal recording condition is not identified.

In addition to functions of recording on an optical recording medium (i.e., optical recording functions) that are provided in general CD-R/RW drives, DVD-R drives, DVD-RW drives and DVD+RW drives, the optical recording apparatus of the present invention requires (1) a function of evaluating the condition for changing the recording beam waveform, and (2) a function of continuing a recording operation by changing the recording beam waveform.

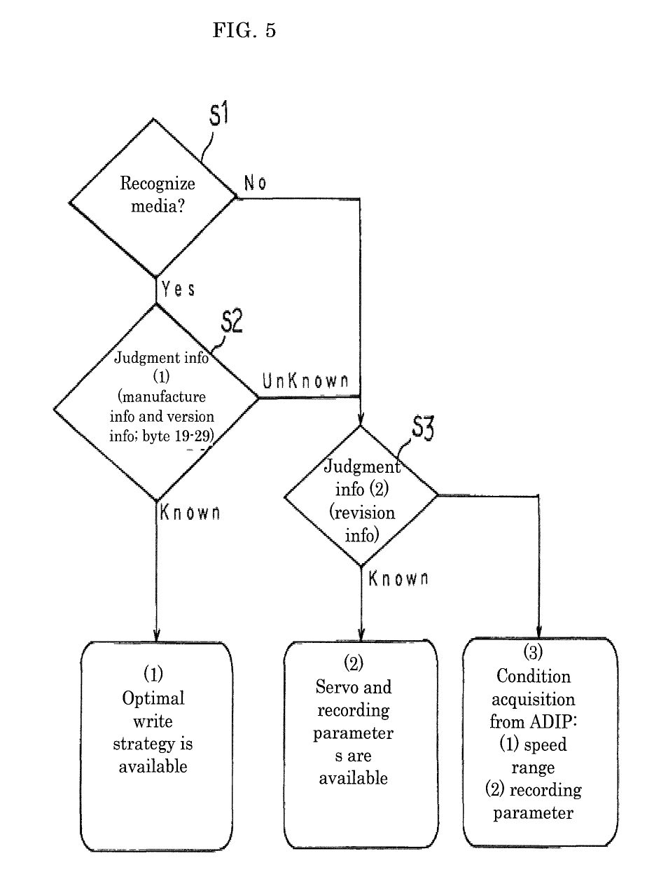

FIG. 5 is an example of a flowchart showing how an optimal recording condition (servo parameter and/or write strategy parameter) for an optical recording medium is determined

The process shown in FIG. 5 consists of three steps: Step 1 (S1) for determining whether or not the recording speed, type, etc., of the optical recording medium is known (i.e., whether or not a drive recognizes the medium); Step 2 (S2) for determining whether or not the manufacturer information and/or version information of the optical recording medium is known; and Step 3 (S3) for determining on the basis of revision information whether or not the manufacturing method of the optical recording medium is known. In the process it is determined to what status does the optical recording apparatus belongs among the following three statuses (1), (2), and (3), and the servo setting and/or write strategy is changed depending on the recording condition identified in each step, thereby achieving media-to-media basis recording condition setting.

Status (1): The optical recording apparatus has an optimal write strategy parameter for the optical recording medium.

Status (2): The optical recording apparatus has a more proper servo parameter and write strategy parameter for the optical recording medium.

Status (3): The optical recording apparatus records information on the basis of the ADIP information.

### EXAMPLES

Hereinafter, the present invention will be described in detail based on Examples and Comparative Examples, which however shall not be construed as limiting the invention thereto.

The effect of the present invention will be described based on Examples.

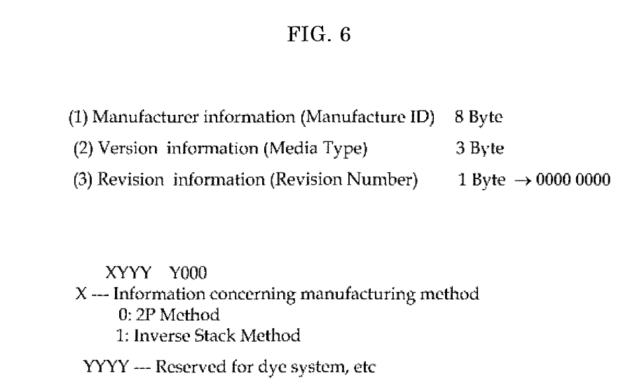

In Examples, dual layer DVD+R (DVD+R_DL) discs were used, where information concerning the manufacturing method of the optical recording medium (i.e., the method of forming a recording layer), or manufacturing information, having an information format shown in FIG. 6, is recorded as wobble of grooves from which signals for the information are produced.

More specifically, the optical recording medium of Example 1 was manufactured with the inverse stack method, where as judgment information “1” is recorded in the region represented by “X” in the information format shown in FIG. 6. The optical recording medium of Example 2 was manufactured with the 2P method, where as judgment information “0” is recorded in the region represented by “X” in the information format shown in FIG. 6. The optical recording medium of Comparative Example 1 was manufactured with the inverse stack method, where no judgment information is recorded in the region represented by “X” in the information format shown in FIG. 6.

In the optical recording media of Examples, the region recording manufacturing information (i.e., the region X in the information format shown in FIG. 6) is the region to which a disc manufacturer can arbitrarily add information (revision information), and conventional recording apparatus never use this region for the recognition of an optical recording medium. For this reason, even recording apparatus that are not supported by the present invention can perform recording and reproducing in the conventional manner.

Using a recording apparatus equipped with units shown in FIG. 3, the optical recording media of Example 1, Example 2 and Comparative Example 1 were evaluated whether or not information can be recorded on or reproduced from them. This recording apparatus adopted a recording beam waveform used for an optical recording medium, the manufacturing method of which is not identified, and adopted a servo condition for an optical recording medium manufactured with the 2P method.

The evaluation results are shown in Table 1.

The optical recording media of Examples 1 and 2 were both successful in information recording and information reproducing. In the optical recording medium of Comparative Example 1, however, recording errors occurred because focusing servo characteristics were not proper.

TABLE 1

| | Evaluation results |
|---|---|
| Ex. 1 | No recording error |
| Ex. 2 | No recording error |
| Compara. Ex. 1 | Recording error occurred |

### Example 3 and Comparative Example 2

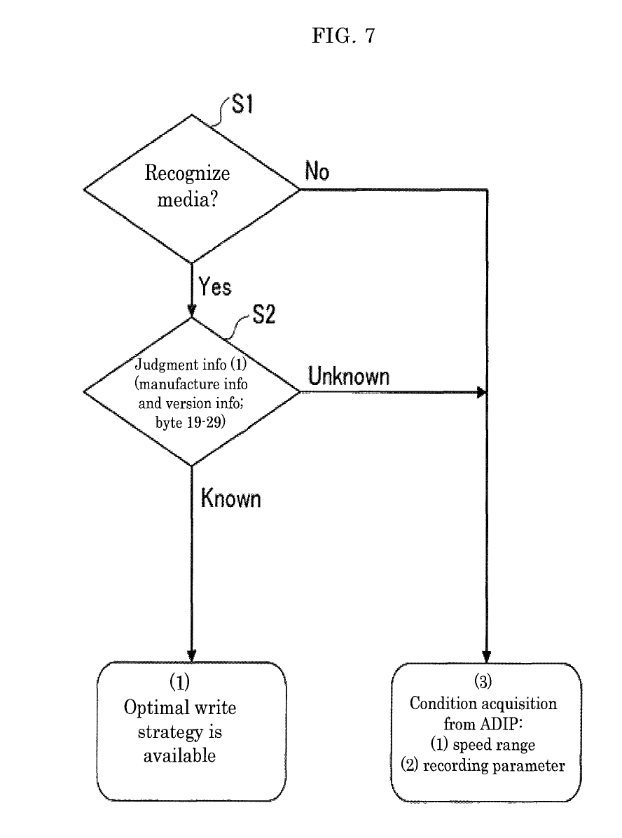

In Example 3 an optical recording apparatus having the function shown FIG. 5 was used. In Comparative Example 2a conventional optical recording apparatus having the function shown in FIG. 7 was used. The process shown in FIG. 7 is identical to that shown in FIG. 5 except that Step 3 is omitted, i.e., the branch (2), or status (2), is omitted and accordingly, remaining Steps (1) and (2) (i.e., branches (1) and (3)) are not changed. Note in the optical recording apparatus of Comparative Example 2 that the servo setting for an unidentified optical recording medium was set to one for the 2P method.

A DVD+R_DL disc manufactured with the inverse stack method (hereinafter referred to as an “optical disc A”) and a DVD+R_DL disc manufactured with the 2P method (hereinafter referred to as an “optical disc B”), both of which having information concerning the manufacturing method (i.e., the method of forming a recording layer) in an information format shown in FIG. 6, were evaluated whether or not information can be recorded on or reproduced from them.

The evaluation results are shown in Table 2. Both information recording and information reproducing were possible with the optical discs A and B prepared in Example 3. In Comparative Example 2, by contrast, a recording error occurred in the optical disc A because focusing servo characteristics were not proper.

TABLE 2

| | Optical Disc A | Optical Disc B |
|---|---|---|
| | (Inverse Stack Method) | (2P Method) |
| Ex. 3 | No recording error | No recording error |
| Compara. Ex. 2 | Recording error occurred | No recording error |

What is claimed is:

1. An optical recording medium comprising:
a substrate; and
a multilayered recording layer disposed on or over the substrate,
wherein judgment information concerning a recording condition for the optical recording medium is previously recorded in such a way that the information can be read out by irradiation with a laser beam, and
wherein information is recorded by irradiating the recording layer with a laser beam to cause change in its optical characteristics.

2. The optical recording medium according to claim 1, wherein the judgment information concerns a method of forming the recording layer.

3. The optical recording medium according to claim 2, wherein the judgment information identifies the method of forming the recording layer on the basis of the presence or absence of information recorded in the substrate.

4. The optical recording medium according to claim 2, further comprising a groove to be scanned with a laser beam upon recording of information in the recording layer,
wherein the judgment information indicates that the thickness of the recording layer provided on convex and concave portions formed by the groove differs depending on the method of forming the recording layer.

5. The optical recording medium according to claim 1, wherein the recording layer is formed by applying a liquid recording material.

6. The optical recording medium according to claim 4, wherein the judgment information is recorded as wobble of the groove.

7. The optical recording medium according to claim 1, wherein the judgment information is recorded as information that has been phase-modulated.

8. The optical recording medium according to claim 1, wherein the judgment information is contained in one of manufacturer information and version information of the optical recording medium.

9. The optical recording medium according to claim 1, wherein in a case where the optical recording medium is one of a DVD+R recording medium and a DVD+RW recording medium, the judgment information is contained in revision information of the optical recording medium.

10. The optical recording medium according to claim 9, wherein in a case where the revision information is 1 byte information, the judgment information is recorded within top 5 bits of the revision information.

11. An optical recording apparatus comprising the functions of:
reading out, as judgment information concerning a recording condition for an optical recording medium, information concerning a method of forming a recording layer from the optical recording medium;
comparing the information thus read out with previously recorded information concerning a method of forming a recording layer; and
setting servo characteristics and/or a recording beam waveform that correspond to the method of forming a recording layer, the method having been identified as a result of the comparison,
wherein, upon recording on an optical recording medium having information concerning the method of forming a recording layer recorded therein, a recording method is changed to a recording method that corresponds to the method of forming a recording layer, and
wherein the optical recording medium comprises a substrate and a multilayered recording layer disposed on or over the substrate, wherein information is recorded by irradiating the recording layer with a laser beam to cause change in its optical characteristics.

12. The optical recording apparatus according to claim 11, wherein a recording beam waveform is changed when the recording method is changed according to the method of forming a recording layer.

13. The optical recording apparatus according to claim 11, wherein servo characteristics are changed when the recording method is changed according to the method of forming a recording layer.

14. The optical recording apparatus according to claim 11, wherein in a case where manufacturer information and/or version information of the optical recording medium is read out and it is determined that a recording method corresponding to the manufacturer information and/or version information is recorded in the optical recording medium before starting recording, recording is performed using the recording method.
